(19) United States
(12) Patent Application Publication
(10) Pub. No.: US 2002/0174756 A1
(43) Pub. Date: Nov. 28, 2002

(54) Deck strips cutting device

(76) Inventor: Mei-Ying Tsuei, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/862,333

(22) Filed: May 23, 2001

(51) Int. Cl. B26D 7/02

(52) U.S. Cl. 83/452; 83/762

(57) ABSTRACT

A desk strips cutting device includes a U-shaped frame having two legs with a connection bar connected between the two legs. A first slit is defined through the connection bar and each of the two legs has a second slit which communicates with the first slits so that a saw blade may move in the first slit and the second slits to cut strips between the two legs. Four locking members movably extend through the connection bar so as to compress the strips in position.

### FIELD OF THE INVENTION

The present invention relates to a cutting device which may cut deck strips at different angles.

### BACKGROUND OF THE INVENTION

A conventional deck strips cutting device known to applicant can only cut the deck strips along an longitudinal axis of the strips and the strips are not well locked in position so that the strips could shifted during the cutting. However, the deck strips are required to have different angles so as to be assembled to be certain patterns, the conventional cutting device cannot provide such function so that the assemblers have to use other tools to obtain these angles on the deck strips.

The present invention intends to provide a U-shaped cutting device that has two legs between which the strips can be arranged at desired angle relative to the device so that the strips can be cut at different angles.

### SUMMARY OF THE INVENTION

In accordance with one aspect of the present invention, there is provided a desk strips cutting device and comprises a frame having two legs with a connection bar connected between the two legs. A first slit is defined through the connection bar and each of the two legs has a second slit which communicates with the first slit for receiving a saw blade therein. Four locking members movably extend through the connection bar to position strips between the two legs.

The primary object of the present invention is to provide a deck strips cutting device that cuts the deck strips at various angles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the deck strips cutting device and one of the four locking members of the present invention;

FIG. 2 is a perspective view to show a saw blade is inserted in the slits in the cutting device of the present invention to cut deck strips between the two legs of the cutting device;

FIG. 3 is a perspective view to show that the deck strips are put on a bottom member and both of which are located between the two legs of the cutting device;

FIG. 4 is a top view to show a cutting line on the deck strips can be seen from the recess in the protrusion of the cutting device, and

FIG. 5 is a top view to show the cutting line on the deck strips can be seen from the recess in the protrusion of the cutting device, wherein the deck strips are put in different angle from that in FIG. 4.

### DETAILED DESCRIPTION OF THE PREFERRED EMBODIMENT

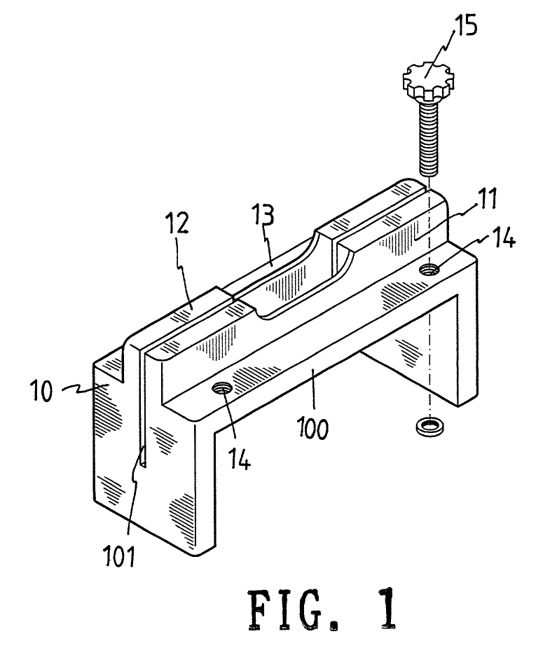

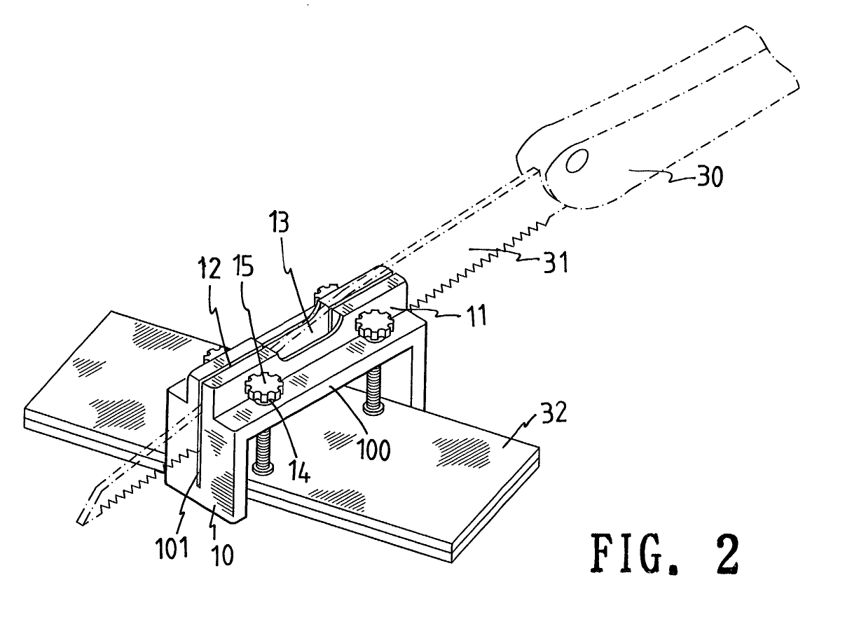

Referring to FIGS. 1 and 2, the deck strips cutting device of the present invention comprises a U-shaped frame having two legs 10 with a connection bar 100 connected between the two legs 10. A first slit 12 is defined through the connection bar 100 and each of the two legs 10 has a second slit 101 defined therein, wherein the first slit 12 communicates with the two respective second slits 101. A protrusion 11 extends from a top of the connection bar 100 and the first slit 12 communicates through the protrusion 11. A recess 13 is defined through the protrusion 11 and communicates with the first slit 12.

Four locking members 15 movably extend through four threaded holes 14 in the connection bar 100 and the four locking members 15 are separated by the protrusion 11 into two groups and each of the two groups has two locking members 15. Each locking member 15 has a pad connected to a lower end thereof so as to be compressed on the deck strips 32 to be cut. It is to be noted that the width between the two legs 10 of the cutting device is wider than the deck strips 32 to be cut so that two sides of the strips 32 can contact the two legs 10 when the strips 32 are put at an angle relative to the saw 30.

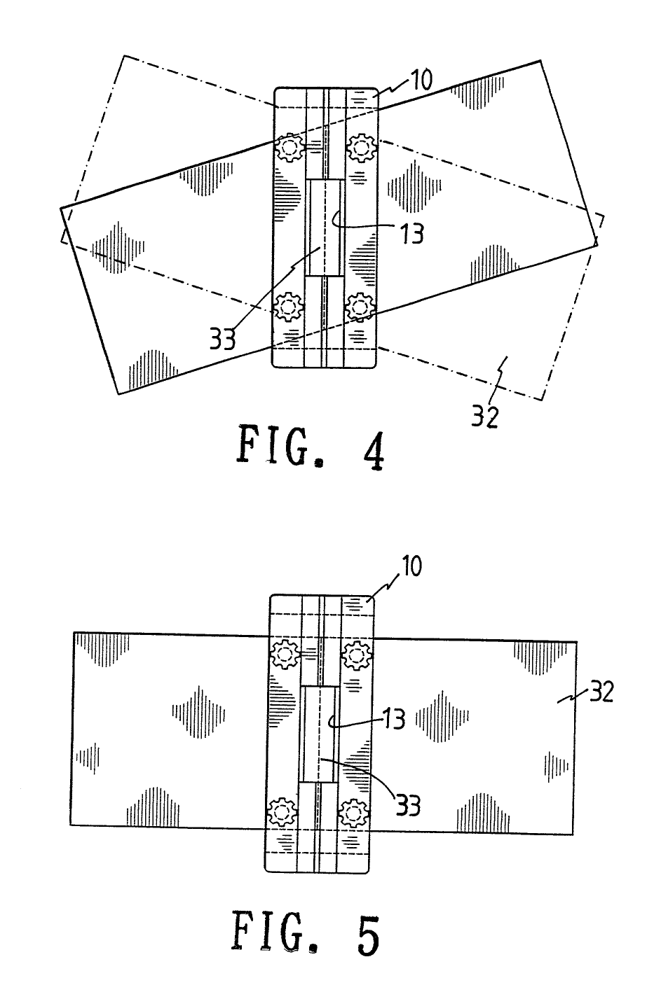

The saw blade 31 of a saw 30 is movably received in the first slit 12 and the second slits 101 and the deck strips 32 are cut by the saw blade 31. A cutting line 33 can be drawn on the strips 32 as shown in FIGS. 4 and 5, and the user may check the alignment of the saw blade 31 and the cutting line 33 via the recess 13 so as to precisely cut the strips at the desired position.

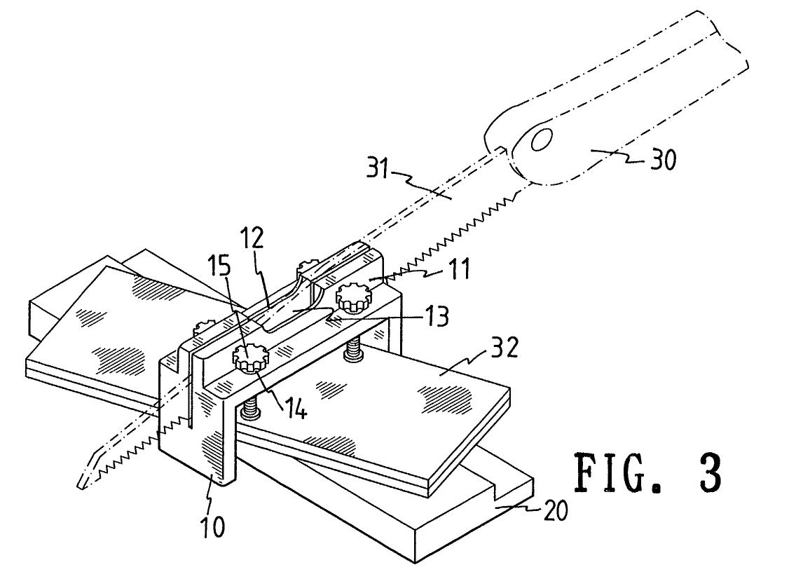

As shown in FIG. 3, a bottom member 20 is put under the strips 32 to be cut so that the strips 32 are located higher and the saw blade 31 may cut through the strips 32 without impacting a hard surface.

While we have shown and described the embodiment in accordance with the present invention, it should be clear to those skilled in the art that further embodiments may be made without departing from the scope of the present invention.

What is claimed is:

1. A desk strips cutting device comprising:
a frame having two legs with a connection bar connected between said two legs, a first slit defined through said connection bar and each of said two legs having a second slit defined therein, said first slit communicating with said two respective second slits, and
four locking members movably extending through said connection bar.

2. The cutting device as claimed in claim 1 further comprising a protrusion extending from a top of said connection bar and said first slit communicating through said protrusion, a recess defined through said protrusion and communicating with said first slit.

3. The cutting device as claimed in claim 2, wherein said four locking members are separated by said protrusion into two groups and each of said two groups has two locking members.
